(19) United States
(12) Patent Application Publication
(10) Pub. No.: US 2019/0111942 A1
(43) Pub. Date: Apr. 18, 2019

(54) METHOD FOR CONVEYING INFORMATION DURING AN AUTONOMOUS DRIVE AND VEHICULAR INFORMATION PRESENTING DEVICE

(71) Applicant: YAZAKI CORPORATION, Tokyo (JP)

(72) Inventors: Yukio Suzuki, Shizuoka (JP); Kenichi Nagahashi, Shizuoka (JP)

(21) Appl. No.: 16/157,340

(22) Filed: Oct. 11, 2018

(30) Foreign Application Priority Data
Oct. 12, 2017 (JP) 2017-198811

(51) Int. Cl. B60W 50/14; G05D 1/00; B60W 10/18; B60W 10/20; B60W 50/00; G07C 5/08; H04W 4/40

(52) U.S. Cl. CPC B60W 50/14; G05D 1/0088; B60W 10/18; B60W 10/20; B60W 50/0097; B60W 2050/007; G07C 5/085; H04W 4/40; B60W 2710/18; B60W 2710/20; B60W 2710/1038; G07C 5/0816

(57) ABSTRACT

If an event that the self vehicle will encounter as it runs along a current course and may disable continuation of an autonomous drive is detected, a warning level is calculated taking into consideration the probability of an encounter, the degree of emergency, the degree of importance, etc. of the event, a form of information presentation and strength of a stimulus are determined automatically according to the warning level, and information is presented with a proper time margin before the vehicle comes close to a position of occurrence of the event. Where the probability of an encounter, the degree of emergency information, and the degree of importance are low, information is presented at a lowest notification level, whereby the comfortability of the autonomous drive can be maintained.

### CROSS REFERENCE TO RELATED APPLICATIONS

This application is based on and claims priority from Japanese patent application No. 2017-198811 filed on Oct. 12, 2017, the entire contents of which are incorporated herein by reference.

### BACKGROUND OF THE INVENTION

### 1. Technical Field

The present invention relates to a method for conveying information during an autonomous drive and a vehicular information presenting device that can be employed in vehicles capable of autonomous driving.

### 2. Background Art

Automobile manufacturers are now developing technologies for automatizing part of drive manipulations and autonomous drive technologies for allowing a system including a computer to perform almost all drive manipulations automatically in place of a driver (refer to Patent documents JP-A-2016-182906 and JP-A-2017-26417).

Patent document JP-A-2016-182906, which relates to a drive assist system, discloses a technique for allowing the driver to recognize a surrounding traffic situation quickly when an autonomous drive is canceled. More specifically, when receiving a notice or an advance notice of switching from an autonomous drive to a manual drive, the system displays, on the display provided in a meter cluster panel, a vehicle speed of the self vehicle, a rear-view video, an image indicating a front road shape, an image indicating locations of vehicles around the self vehicle, and an image indicating a distance to the vehicle immediately ahead and a situation around it.

Patent document JP-A-2017-26417, which relates to an information presenting system, discloses a technique for presenting information recognized by an autonomous driving system to the driver in response to his or her instruction. More specifically, the information presenting system switches the display mode of a display unit in response to a display switching instruction from the driver. The information presenting system has a display mode in which to display set information of an autonomous drive, a display mode in which to display running information during operation of the autonomous driving system, and a display mode in which to display recognition result information of the autonomous driving system.

### SUMMARY

Incidentally, while a vehicle in which an autonomous driving system is installed is doing an autonomous drive, it may encounter a situation that the system cannot deal with properly. In such a situation, it is expected that the drive of the vehicle is continued according to judgments and drive manipulations of the driver by switching, for example, from an autonomous drive mode to a manual drive mode (a handover from the system to the driver) or, if it is impossible, the vehicle is stopped automatically. Alternatively, switching may be made from an autonomous drive mode in which no assistance from the driver is necessary at all to an autonomous drive mode in which assistance from the driver is necessary.

To enable a smooth handover from the autonomous drive mode to the manual drive mode, it is necessary for the system to arouse attention of the driver by a certain means before occurrence of an actual handover to urge him or her to prepare for the handover.

However, each of various handover-causing situations predicted by the system may either occur or does not occur actually. That is, after the system predicts a possible situation that the autonomous drive mode cannot be continued, in actuality a handover may become necessary or the autonomous drive may continue because of issuance of no handover request from the system.

One specific example handover-causing drive situation is a situation that the self vehicle has reached an area for which no map data necessary for an autonomous drive is available. In this situation, a handover occurs because it is difficult to continue an autonomous drive.

On the other hand, when it is probable that sensors necessary for an autonomous drive will not operate normally due to a rainfall or a snow fall that may occur in an area located ahead in the course of the self vehicle, a situation may occur that an autonomous drive cannot be continued. However, it is not always the case that such a situation occurs, contrary to the prediction.

Thus, if a message such as “Prepare for a manual drive” is issued to arouse attention of the driver every time the system predicts occurrence of a situation that an autonomous drive cannot be continued, it may bother the driver much. In other words, whereas there will be no problem if a handover request is issued actually after arousing attention of the driver, if a handover request is not issued actually after arousing attention of the driver the comfortability of the autonomous drive is impaired for a while after the arousing of attention of the driver because the driver needs to be ready for a handover.

Furthermore, if the details of an autonomous drive are different from what the driver thinks or predicts, the driver may be surprised by an autonomous drive control (what is called an automation surprise). Such an automation surprise may cause the driver to distrust the autonomous driving of his or her own vehicle. For example, if another vehicle changes the course and cuts in ahead of the self vehicle, the driver would expect that the autonomous drive of his or her own vehicle will cause deceleration. However, in actuality, the autonomous drive may select a lane change instead of deceleration, in which case the driver is forced to manipulate the steering wheel with his or her hands hastily. The driver may think that the autonomous driving is not reliable. It is therefore important to present proper information to the driver during an autonomous drive.

The present invention has been made in view of the above circumstances, and an object of the invention is therefore to provide a method for conveying information during an autonomous drive and a vehicular information presenting device that can smoothly switch from a first state in which a drive control is performed automatically to a second state that is higher in the degree of involvement of a driver in drive control than the first state when the switching is necessary, and that can suppress lowering of the comfortability of an autonomous drive due to prediction of an uncertain situation.

To attain the above object, the invention provides methods for conveying information during an autonomous drive and vehicular information presenting devices having features that will be described below in the form of items (1) to (9):

(1) A method for conveying information during an autonomous drive which presents information to a driver in a vehicle having, as running states, two or more states that are different from each other in the degree of involvement of the driver in drive control, wherein:

the running states include a first state in which the drive control is performed automatically and a second state that is higher in the degree of involvement of the driver in drive control than the first state; and

if an encounter with an event that may cause switching from the first state to the second state is predicted, information relating to the event is conveyed to the driver using an output device in an output form that corresponds to a warning level relating to the predicted event.

According to the method for conveying information during an autonomous drive of item (1), since information relating to a predicted event is conveyed to the driver in an output form that corresponds to a warning level, proper information conveyance is realized taking into consideration the probability of encountering the event, the degree of emergency that indicates a time margin, and the degree of importance that indicates the seriousness of damage to be incurred by a resulting traffic accident. Thus, for example, if an encounter with an event whose probability of an encounter, degree of emergency, and degree of importance are low is predicted, information conveyance is performed in an output form of a lowest notification level, whereby the driver is prevented from preparing for a probable handover excessively. This makes it possible to suppress a phenomenon that the comfortability of an autonomous drive is lowered by prediction of an uncertain situation.

For another example, if an encounter with an event whose probability of an encounter, degree of emergency, or degree of importance is high is predicted, information conveyance is performed in an output form having an explicit expression, which allows the driver to start preparing for a handover before issuance of a handover request. A smooth handover can therefore be realized.

(2) The method for conveying information during an autonomous drive according to item (1), wherein:

the first state is a state in which the running speed and direction of the vehicle are controlled automatically and no assistance of the driver to the drive control is necessary; and

the second state is a state in which the running speed and direction of the vehicle are controlled automatically but assistance of the driver to the drive control is required.

According to the method for conveying information during an autonomous drive of item (2), information conveyance to the driver can be performed properly also when an encounter with an event is predicted that may cause the vehicle running state to make a transition from a state in which no assistance of the driver is necessary to a state in which assistance of the driver is required. For example, information conveyance can be performed properly when a transition is made from a running state in which no assistance of the driver such as placing the hands on the steering wheel, assuming a duty to watch, starting of a lane change beginning with a blinker manipulation, and approval of a judgment of the system is necessary during an autonomous drive of the vehicle to a running state in which at least one of these kinds of assistance is necessary.

(3) The method for conveying information during an autonomous drive according to item (1), wherein:

the first state is a state in which the running speed and direction of the vehicle are controlled automatically; and

the second state is a state in which at least one of the running speed and the running direction of the vehicle is controlled by the driver.

According to the method for conveying information during an autonomous drive of item (3), information conveyance to the driver can be performed properly also when an encounter with an event is predicted that may cause the vehicle running state to make a transition from a state in which the running speed and direction of the vehicle are controlled automatically to a state in which at least one of the running speed and the running direction of the vehicle is controlled by the driver. For example, information conveyance can be performed properly when a transition is made from a running state in which the running speed and direction of the vehicle are controlled automatically (whether assistance of the driver such as placing the hands on the steering wheel, assuming a duty to watch, starting of a lane change beginning with a blinker manipulation, and approval of a judgment of the system is necessary is irrelevant) to a complete manual drive state or a running state in which only one of the running speed and the running direction is controlled automatically.

(4) The method for conveying information during an autonomous drive according to item (1), wherein:

the warning level relates to at least one of the probability of an encounter that is a probability of encountering the predicted event, the degree of emergency that indicates a time margin, and the degree of importance that indicates the seriousness of damage to be incurred by a resulting traffic accident; and

the output device is controlled so as to make a stimulus to be imparted to the driver weaker when the warning level is low than when the warning level is high.

According to the method for conveying information during an autonomous drive of item (4), since the stimulus to be imparted to the driver is made weak if the probability of an encounter, the degree of emergency, and the degree of importance are low, information conveyance can be performed in an output form of a lowest notification level. Since the stimulus to be imparted to the driver is made strong if the probability of an encounter, the degree of emergency, or the degree of importance is high, information conveyance can be performed in an output form having an explicit expression.

(5) A vehicular information presenting device for presenting information to a driver in a vehicle having, as running states, two or more states that are different from each other in the degree of involvement of the driver in drive control, wherein:

the running states include a first state in which the drive control is performed automatically and a second state that is higher in the degree of involvement of the driver in drive control than the first state; and

the vehicular information presenting device comprises:
an event prediction unit which predicts an encounter with an event that may cause switching from the first state to the second state; and
an information output control unit which conveys information relating to the event to the driver using an output device in an output form that corresponds to a warning level relating to the predicted event if the event prediction unit predicts an encounter with the event.

According to the vehicular information presenting device having the configuration of item (5), since information relating to a predicted event is conveyed to the driver in an output form that corresponds to a warning level, proper information conveyance is realized taking into consideration the probability of an encounter, the degree of emergency, and the degree of importance that that relate to the event. Thus, for example, if an encounter with an event whose probability of an encounter, degree of emergency, and degree of importance are low is predicted, information conveyance is performed in an output form of a lowest notification level, whereby the driver is prevented from preparing for a probable handover excessively. This makes it possible to suppress a phenomenon that the comfortability of an autonomous drive is lowered by prediction of an uncertain situation.

For another example, if an encounter with an event whose probability of an encounter, degree of emergency, or degree of importance is high is predicted, information conveyance is performed in an output form having an explicit expression, which allows the driver to start preparing for a handover before issuance of a handover request. A smooth handover can therefore be realized.

(6) The vehicular information presenting device according to item (5), wherein:

the first state is a state in which the running speed and direction of the vehicle are controlled automatically and no assistance of the driver to the drive control is necessary; and

the second state is a state in which the running speed and direction of the vehicle are controlled automatically but assistance of the driver to the drive control is required.

According to the vehicular information presenting device having the configuration of item (6), information conveyance to the driver can be performed properly also when an encounter with an event is predicted that may cause the vehicle running state to make a transition from a state in which no assistance of the driver is necessary to a state in which assistance of the driver is required. For example, information conveyance can be performed properly when a transition is made from a running state in which no assistance of the driver such as placing the hands on the steering wheel, assuming a duty to watch, starting of a lane change beginning with a blinker manipulation, and approval of a judgment of the system is necessary during an autonomous drive of the vehicle to a running state in which at least one of these kinds of assistance is necessary.

(7) The vehicular information presenting device according to item (5), wherein:

the first state is a state in which the running speed and direction of the vehicle are controlled automatically; and

the second state is a state in which at least one of the running speed and the running direction of the vehicle is controlled by the driver.

According to the vehicular information presenting device having the configuration of item (7), information conveyance to the driver can be performed properly also when an encounter with an event is predicted that may cause the vehicle running state to make a transition from a state in which the running speed and direction of the vehicle are controlled automatically to a state in which at least one of the running speed and the running direction of the vehicle is controlled by the driver. For example, information conveyance can be performed properly when a transition is made from a running state in which the running speed and direction of the vehicle are controlled automatically irrespective of whether assistance of the driver such as placing the hands on the steering wheel, assuming a duty to watch, starting of a lane change beginning with a blinker manipulation, and approval of a judgment of the system is necessary to a complete manual drive state or a running state in which only one of the running speed and the running direction is controlled automatically.

(8) The vehicular information presenting device according to item (5), wherein the event prediction unit has a function of acquiring at least one of weather information and traffic information at places ahead of the vehicle on a scheduled drive route and predicts an encounter with the event using prescribed road map information, the weather information, and the traffic information.

According to the vehicular information presenting device having the configuration of item (8), since weather information and traffic information are acquired, information conveyance relating to an encounter with the event to the driver can be started at a position that is well short of the place of the event.

(9) The vehicular information presenting device according to item (5), wherein the information output control unit causes the output device to output a stimulus with such strength that it is noticed by the driver if the warning level is relatively low, and to output an explicit message if the warning level is relatively high.

In the vehicular information presenting device having the configuration of item (9), if the probability of an encounter, the degree of emergency, and the degree of importance are low, information conveyance is performed in an output form of a lowest notification level. Thus, the driver can be prevented from preparing for a probable handover excessively. If the probability of an encounter, the degree of emergency, or the degree of importance is high, information conveyance is performed in an output form having an explicit expression, which allows the driver to start preparing for a handover before issuance of a handover request. A smooth handover can therefore be realized.

The method for conveying information during an autonomous drive and the vehicular information presenting device according to the invention can smoothly switch from a first state in which a drive control is performed automatically to a second state that is higher in the degree of involvement of a driver in drive control than the first state when the switching is necessary and can suppress lowering of the comfortability of an autonomous drive due to prediction of an uncertain situation.

The invention has been described above concisely. The details of the invention will become more apparent when the modes for carrying out the invention (hereinafter referred to as an embodiment) described below are read through with reference to the accompanying drawings.

### BRIEF DESCRIPTION OF THE DRAWINGS

FIG. 1 is a block diagram showing an example configuration of a main part of a vehicular system including a vehicular information presenting device according to an embodiment of the present invention.

FIG. 2 is a flowchart showing an example process characteristic of the vehicular information presenting device according to the embodiment.

FIGS. 3A and 3B illustrate a specific example of how the vehicular information presenting device operates differently for different states (drive environments) of a drive of a self vehicle running on a road.

FIG. 4 shows a relationship between respective situations for individual intervals to an event-occurring position and target recognition levels of the driver.

### DETAILED DESCRIPTION OF EMBODIMENTS

A specific embodiment of the present invention will be hereinafter described with reference to the drawings.

### <Example Configuration of Essential Part of Vehicular System>

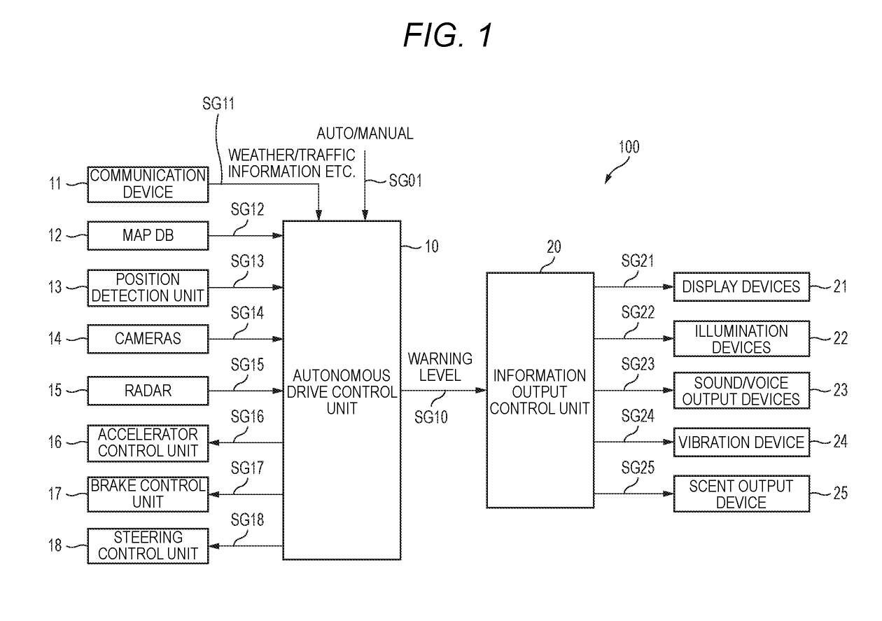

FIG. 1 shows an example configuration of a main part of a vehicular system including a vehicular information presenting device 100 according to the embodiment of the invention. This vehicular system includes functions for driving an automobile autonomously and the vehicular information presenting device 100 which presents information relating to an autonomous drive to the driver.

The vehicular system shown FIG. 1 is equipped with, as constituent elements necessary to drive the automobile autonomously, an autonomous drive control unit 10, a wireless communication device 11, a road map database (DB) 12, a position detection unit 13, vehicular cameras 14, a radar 15, an accelerator control unit 16, a brake control unit 17, and a steering control unit 18.

Connecting to a prescribed server located outside the vehicle by a wireless communication, the wireless communication device 11 can acquire weather information, traffic information, etc. at places, located ahead in the running direction, along the road on which the self vehicle is running currently. Weather information, traffic information, etc. acquired by the wireless communication device 11 are input to the autonomous drive control unit 10 as input information SG11.

A wide-range road map including the road on which the self vehicle is running currently and various kinds of information relating to the roads are accumulated in advance and held in the road map database 12. Information, such as map data, held by the road map database 12 is input to the autonomous drive control unit 10 as input information SG12.

The position detection unit 13 can calculate latest position information indicating a current position of the self vehicle by receiving and using radio waves coming from, for example, GPS (global positioning system) satellites. This position information is input to the autonomous drive control unit 10 as input information SG13.

The vehicular cameras 14 can take videos representing situations around (e.g., ahead of, behind, and beside) the self vehicle and output resulting video signals. The video signals are input to the autonomous drive control unit 10 as input information SG14.

The radar 15 can detect presence/absence of an obstacle such as the vehicle running immediately ahead, an intervehicle distance between the vehicle immediately ahead and the self vehicle, and other information by a detecting function utilizing radio waves such as millimeter waves. Information detected by the radar 15 is input to the autonomous drive control unit 10 as input information SG15.

The accelerator control unit 16 is equipped with an actuator that is necessary to adjust the accelerator position of the self vehicle automatically and can be controlled electrically. The accelerator control unit 16 can adjust the accelerator position according to an output signal SG16 that is output from the autonomous drive control unit 10.

The brake control unit 17 is equipped with actuators that are connected to brake mechanisms of the self vehicle and can be controlled electrically. The brake control unit 17 can control turning-on/off of the brakes of the self vehicle and the degrees of their braking according to an output signal SG17 that is output from the autonomous drive control unit 10.

The steering control unit 18 is equipped with an actuator that is connected to a steering mechanism of the self vehicle and can be controlled electrically. The steering control unit 18 can move the steering mechanism of the self vehicle or generate assist torque for assisting steering force of the driver according to an output signal SG18 that is output from the autonomous drive control unit 10.

The autonomous drive control unit 10 is an electronic control unit (ECU) for performing an autonomous drive control on an automobile and is provided with functions for performing autonomous driving of level-2 (LV2) or level-3 (LV3) among the automation levels prescribed by, for example, the Japanese government or the National Highway Traffic Safety Administration (NHTSA) of the U.S. Department of Transportation.

At level-2, the system automatically performs manipulations of plural ones of acceleration, steering, and braking of the vehicle. However, at level-2, the driver needs to watch the drive situation all the time and perform a drive manipulation when necessary.

On the other hand, at level-3, since the system controls all of acceleration, steering, and braking of the vehicle, usually the driver is required to merely watch the drive situation or even need not watch the drive situation. However, even at level-3, the driver needs to respond to a request from the system in the event of emergency or the system's reaching a limit of control. That is, it is necessary to hand over (H/O) the responsibility of driving from the system to the manual manipulation by the driver and to make a transition from level-3 to level-2 or the like which is lower in the degree of automation than level-3. Even where the automation level is kept the same, a transition may be made from a running state in which assistance from the driver such as placing his or her hands on the steering wheel, assuming a duty to watch, starting of a lane change beginning with a blinker manipulation, and approval of a judgment of the system is not necessary during an autonomous drive of the self vehicle to a running state in which one or some of those kinds of assistance are necessary. That is, a transition may be made from a first state in which a drive control is performed automatically to a second state that is lower in the degree of involvement of the driver in drive control than the first state.

The autonomous drive control unit 10 can perform an acceleration control on the self vehicle by instructing the accelerator control unit 16 using an output signal SG16. The autonomous drive control unit 10 can perform a braking control on the self vehicle by instructing the brake control unit 17 using an output signal SG17. Furthermore, the autonomous drive control unit 10 can perform a steering control on the self vehicle by instructing the steering control unit 18 using an output signal SG18.

By analyzing videos of the vehicular cameras 14, the autonomous drive control unit 10 can recognize white lines at the boundaries between running lanes and a position of the self vehicle in the left-right direction and thereby calculate a proper position of the self vehicle in the left-right direction and recognize, for example, how a road ahead is curved. In this manner, the autonomous drive control unit 10 can realize a lane keeping assist function of performing an automatic control so that, for example, the self vehicle runs at the center of a running lane of a road.

The autonomous drive control unit 10 can perform acceleration and deceleration automatically on the basis of results of analysis of videos taken by the vehicular cameras 14 and position information and distance information of the vehicle immediately ahead detected by the radar 15 so that, for example, the intervehicle distance between the vehicle immediately ahead and the self vehicle is kept within a safe range. That is, an ACC (adaptive cruise control system) can be realized.

The autonomous drive control unit 10 can calculate a proper running route the self vehicle should take and predict a variation of a road situation ahead on the basis of a target place determined in advance, a current position detected by the position detection unit 13, a road map of the road map database 12, traffic information acquired by the wireless communication unit 11, and other information. The accuracy of prediction can be increased by causing it to reflect analysis results of actual videos taken by the vehicular cameras 14.

The autonomous drive control unit 10 can cause a handover for a transition from level-3 to a level such as level-2 that is lower in the degree of automation than level-3 in response to an auto/manual switching instruction SG01 that is generated in response to, for example, a switch manipulation of the driver.

The autonomous drive control unit 10 can detect a current road situation on the basis of analysis results of videos taken by the vehicular cameras 14, distance information detected by the radar 15, and other information. Furthermore, the autonomous drive control unit 10 can predict, to a certain extent, an event that the vehicle may encounter at a place ahead by using weather information, traffic information, etc. acquired by the wireless communication device 11.

For example, if it is expected that the various sensors on the vehicle may be lowered in detection accuracy due to a rainfall or the like, it may be difficult to continue a level-3 autonomous drive, that is, a handover from level-3 to, for example, level-2 may occur. Not only can a weather situation such as a rainfall and a traffic situation at a current place be detected at present but also such situations to be encountered at a place ahead can be predicted in advance on the basis of information acquired by the wireless communication device 11.

Thus, an encounter with an event such as a rainfall occurring at a place ahead that may cause a handover is predicted, the autonomous drive control unit 10 outputs an alarm level SG10 as a signal indicating it. The alarm level SG10 may contain information indicating a type of a predicted event. The alarm level SG10 is input to an information output control unit 20.

The information output control unit 20 is an electronic control unit (ECU) that performs a control for presenting information necessary during an autonomous drive to the driver. The autonomous drive control unit 10 and the information output control unit 20 which are shown in FIG. 1 may be integrated together.

The vehicular information presenting device 100 according to the embodiment consists of part of the functions of the autonomous drive control unit 10 and at least one of the information output control unit 20, display devices 21, illumination devices 22, sound/voice output devices 23, a vibration device 24, and a scent output device 25.

The display devices 21 are display devices such as a meter unit and a center display that are installed in the vehicle at such locations as to be able to be visually recognized easily by the driver who is driving the vehicle at the driver seat.

The illumination devices 22 are various illumination devices installed in the vehicle. The sound/voice output devices 23 are various auditory output devices including an audio device. The vibration device 24 is a device capable of generating mechanical vibration by an electrical control. So that the driver can recognize vibration as a tactile sensation or the like during a drive, the vibration device 24 is attached or connected to a sitting portion of the driver seat or the steering wheel.

The scent output device 25 is a device capable of generating a particular scent in the vehicle compartment by an electrical control. The scent output device 25 is installed inside a vehicle air conditioner, for example, and can diffuse a scent in the inside space of the vehicle compartment through ventilation.

The information output control unit 20 can present necessary information to the driver by selecting one or plural ones of the display devices 21, the illumination devices 22, the sound/voice output devices 23, the vibration device 24, and the scent output device 25 according to a warning level SG10 that is input from the autonomous drive control unit 10. The information output control unit 20 can present information in various forms and adjusts the intensity of information presentation by using a proper one(s) of the various kinds of devices as needed.

### <Necessity of Using a Proper One(s) of Various Manners of Information Presentation and Intensity of Information Presentation>

When a vehicle provided with an autonomous drive system is doing an autonomous drive, it may encounter a situation that the system cannot deal with properly. In such a situation, it is expected that the drive of the vehicle is continued according to judgments and drive manipulations of the driver by making, for example, a handover from an autonomous drive mode to a manual drive mode or, if it is impossible, the vehicle is stopped automatically.

To enable a smooth handover from the autonomous drive mode to the manual drive mode smoothly, it is necessary for the system to arouse attention of the driver by a certain means before making an actual handover and urge him or her to prepare for the handover.

However, each of various handover-causing situations predicted by the system may either occur or does not occur actually. That is, after the system predicts a situation that the autonomous drive mode cannot be continued, in actuality a handover may become necessary or the autonomous drive may continue because of issuance of no handover request from the system.

One example handover-causing drive situation is a situation that the self vehicle has reached an area for which no map data necessary for an autonomous drive is available. In this situation, a handover occurs because it is difficult to continue an autonomous drive.

On the other hand, when it is probable that sensors necessary for an autonomous drive will be lowered in detection accuracy due to a rainfall or a snow fall that may occur in an area located ahead in the course of the self vehicle, a situation may occur that the system cannot deal with properly. However, it is not always the case that such a situation occurs. For another example, a handover-causing situation also tends to occur at places where a course change likely occurs such as a place where a traffic congestion has occurred actually and a place where a road branches off or merges with another road. However, it is not always the case that a situation that causes a handover occurs.

Thus, if a message such as “Prepare for a manual drive” is issued to arouse attention of the driver every time the system predicts occurrence of a situation that a handover will occur, it may bother the driver much. In other words, whereas there will be no problem if a handover request is issued actually after arousing attention of the driver, if a handover request is not issued actually after arousing attention of the driver the comfortability of the autonomous drive is impaired for a while after the arousing of attention of the driver because the driver needs to be ready for a handover.

In view of the above, the vehicular information presenting device 100 according to the embodiment presents information in such a manner as not to lower the comfortability of the driver during an autonomous drive by an unnecessarily high degree of arousing of his or her attention. More specifically, when detecting an event that may cause a handover such as an event that will disable continuation of an autonomous drive, the vehicular information presenting device 100 automatically selects a proper conveyance method or proper intensity of conveyance taking into consideration the probability of encountering that event, the degree of emergency that indicates a time margin, and the degree of importance that indicates the seriousness of damage to be incurred by a resulting traffic accident. If the probability of encountering the event, the degree of emergency, or the degree of importance is high, the vehicular information presenting device 100 can urge the driver to prepare for a handover by conveying information by an explicit expressing method through, for example, output of a message.

### <Example Process Characteristic of Vehicular Information Presenting Device>

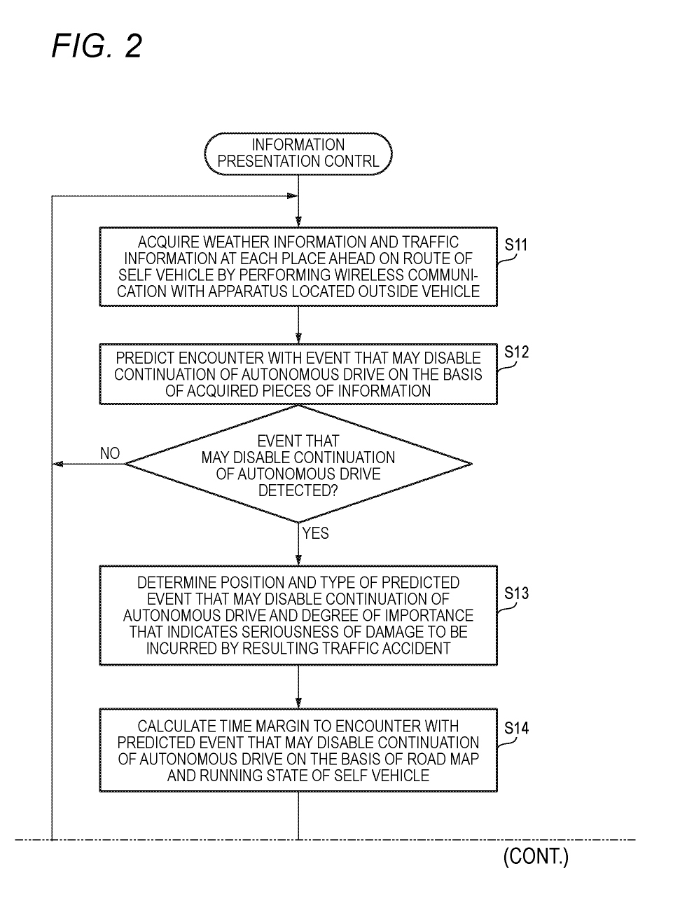

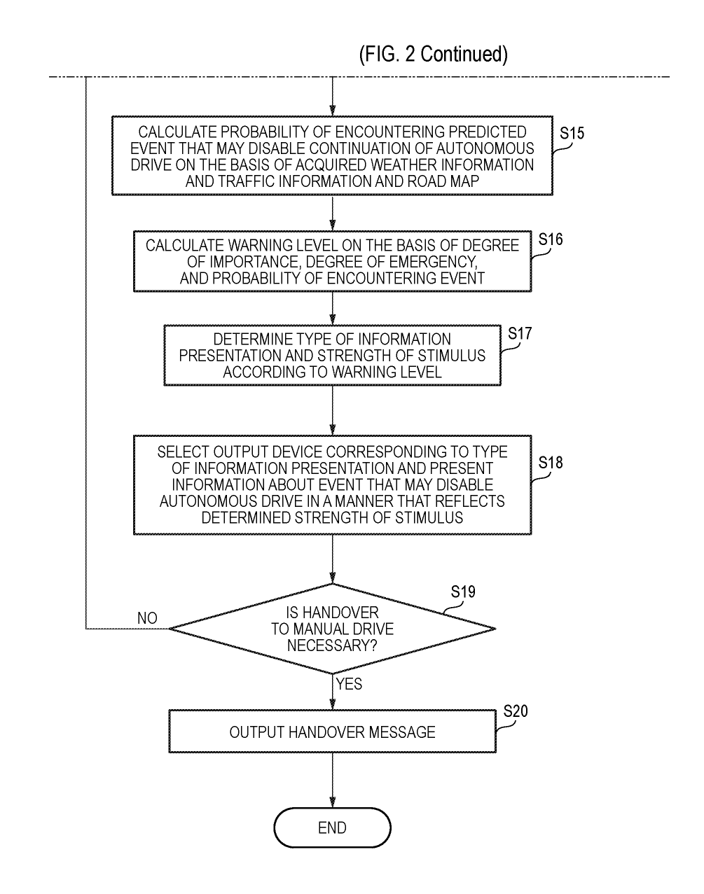

FIG. 2 shows an example process characteristic of the vehicular information presenting device 100 according to the embodiment. That is, the process characteristic of the invention is realized as a result of execution of the steps shown in FIG. 2 by the autonomous drive control unit 10 and the information output control unit 20 shown in FIG. 1. The example process shown in FIG. 2 will be described below.

At step S11, the autonomous drive control unit 10 acquires weather information and traffic information at each place ahead on a route of the self vehicle by performing a wireless communication 11 with an apparatus located outside the vehicle. At step S12, the autonomous drive control unit 10 predicts an encounter with an event that may disable continuation of an autonomous drive on the basis of the acquired pieces of weather information and traffic information and predetermined judgment criteria. If detecting an event that may disable continuation of an autonomous drive, the autonomous drive control unit 10 moves to step S13.

At step S13, the autonomous drive control unit 10 determines a position and a type of the predicted event that may disable continuation of an autonomous drive and the degree of importance that indicates the seriousness of damage to be incurred by a resulting traffic accident. At step S14, the autonomous drive control unit 10 calculates an available time (the degree of emergency) to an encounter with the predicted event that may disable continuation of an autonomous drive on the basis of a road map of the road map database 12 and a running state (vehicle speed etc.) of the self vehicle.

At step S15, the autonomous drive control unit 10 calculates a probability of encountering the predicted event that may disable continuation of an autonomous drive on the basis of the weather information and the traffic information acquired at step S11 and the road map. For example, if an even that may disable continuation of an autonomous drive due to a rainfall is detected, the autonomous drive control unit 10 takes amounts of rainfalls at the respective places into consideration. That is, the probability of encountering the event is set higher as the amounts of rainfalls increase.

At step S16, the autonomous drive control unit 10 calculates a warning level SG10 on the basis of the degree of importance calculated at step S13, the degree of emergency calculated at step S14, and the probability of encountering the event calculated at step S15. The autonomous drive control unit 10 gives the calculated warning level SG10 to the information output control unit 20.

At step S17, the information output control unit 20 determines a type of information presentation and strength of a stimulus according to the received warning level SG10. At step S18, the information output control unit 20 selects an output device corresponding to the type of information presentation and presents information about the event that may disable an autonomous drive in a manner that reflects the determined strength of a stimulus.

If execution of a handover from the autonomous drive to a manual drive is determined (S19: yes), at step S20 the information output control unit 20 causes, for example, (one of) the display devices 21 or (one of) the sound/voice output devices 23 to output a handover message and thereby conveys the situation to the driver reliably by an explicit expressing method at a position short of a position of occurrence of the handover. In this manner, the handover can be made smoothly.

### <Specific Example Operation of Vehicular Information Presenting Device>

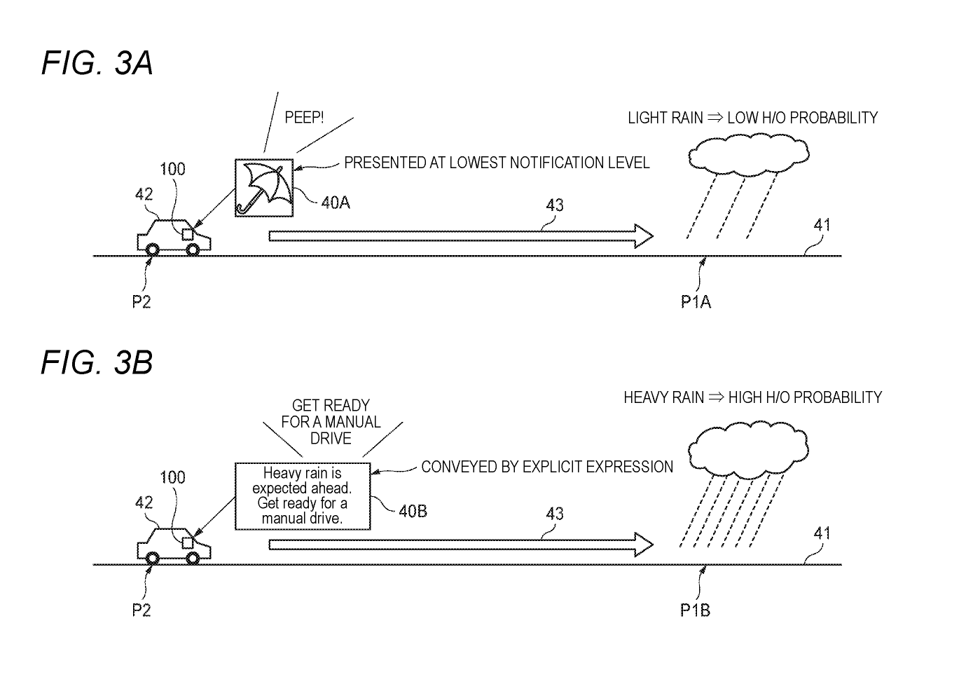

FIGS. 3A and 3B illustrate a specific example of how the vehicular information presenting device 100 operates differently for different states (drive environments) of a drive of a self vehicle 42 running on a road 41.

### <State of FIG. 3A>

FIG. 3A illustrates an example state that the self vehicle 42 provided with the vehicular information presenting device 100 is running on the road 41 in a direction 43 in an autonomous drive mode (level-3) and a relatively little rain is falling at an event-occurring position P1A that is a little (e.g., one to several kilometers) ahead of the current position P2.

In this case, when the self vehicle 42 comes close to the event-occurring position P1A, there may occur a situation that continuation of the autonomous drive is disabled by, for example, lowering in detection accuracy of the various sensors installed in the self vehicle 42 due to the rainfall. Upon occurrence of that situation, a handover from the autonomous drive mode to the manual drive mode is made. However, in the example of FIG. 3A, the probability that a handover will occur actually would be low because the rainfall is light.

Thus, in the state of FIG. 3A, if the vehicular information presenting device 100 aroused attention of the driver in an explicit manner about a handover but a handover did not occur actually, the driver would be forced to be kept ready for a handover during a period when the self vehicle 42 runs from the position P2 to the event-occurring position P1A and hence the comfortability of the autonomous drive would be impaired. On the other hand, if a handover occurred without any advance notice, the driver would be confused.

In the embodiment, since the vehicular information presenting device 100 performs the control shown in FIG. 2, for a light rainfall, the probability of an encounter that is calculated at step S15 is low and hence the warning level calculated at step S16 is also low. When the vehicular information presenting device 100 executes step S18 on the basis of this warning level, low-intensity information presentation is made as shown in FIG. 3A, for example.

More specifically, in the example of FIG. 3A, at the current position P2, the vehicular information presenting device 100 outputs presentation information 40A that is an icon representing an umbrella and a short “peep” sound as “information presentation at a lowest notification level.” With this kind of information presentation, the driver merely recognizes that he or she may encounter a rainfall and hence the comfortability of the autonomous drive is not lowered.

Although in the example of FIG. 3A icon display and sound emission are employed, another kind of information presentation may be made. For example, a control may be made so as to change the ambient brightness a little by controlling the illumination devices 22, to generate weak vibration by the vibration device 24, or generate a slight scent by the scent output device 25.

### <State of FIG. 3B>

FIG. 3B illustrates an example state that the self vehicle 42 provided with the vehicular information presenting device 100 is running on the road 41 in the direction 43 in an autonomous drive mode (level-3) and relatively heavy rain is falling at an event-occurring position P1B that is a little (e.g., one to several kilometers) ahead of the current position P2.

In this case, it is highly probable that continuation of the autonomous drive will be disabled by, for example, lowering in detection accuracy of the various sensors installed in the self vehicle 42 due to the rainfall when the self vehicle 42 comes close to the event-occurring position P1B. Upon occurrence of that situation, a handover from an autonomous drive mode to a manual drive mode is made. A handover request from the autonomous drive mode to a manual drive mode should be issued in the autonomous drive control unit 10.

If a handover request is issued suddenly when the self vehicle 42 has come close to the event-occurring position P1B, the driver cannot accommodate the handover smoothly because he or she is not mentally ready for a start of a manual drive.

In view of the above, in the embodiment, as shown in FIG. 3B, the vehicular information presenting device 100 conveys a notice to the effect that a handover will occur at a high probability to the driver by an explicit expressing method at the current position P2 which is well short of the event-occurring position P1B. This allows the driver to prepare for a handover keeping his or her composure in a period when the self vehicle 42 runs from the position P2 to the event-occurring position P1B. A smooth handover can thus be realized.

Since the vehicular information presenting device 100 performs the control shown in FIG. 2, for a heavy rainfall, the probability of an encounter that is calculated at step S15 is high and hence the warning level calculated at step S16 is also high. When the vehicular information presenting device 100 executes step S18 on the basis of this warning level, high-intensity information presentation is made as shown in FIG. 3B, for example.

More specifically, in the example of FIG. 3B, at the current position P2, the vehicular information presenting device 100 “conveys by an explicit expressing method” presentation information 40B, that is, displays a message “Heavy rain is expected ahead. Get ready for a manual drive” and causes (one of) the sound/voice output devices 23 to output the same or similar message in the form of a simulated voice.

Receiving this kind of information presentation, the driver clearly recognizes that he or she should accommodate a handover from the autonomous drive to a manual drive and hence can prepare for it keeping his or her composure before actual issuance of a handover request.

<Example Operations Performed Before and after Handover>

When the vehicular information presenting device 100 causes a handover by outputting a handover message at step S20 shown in FIG. 2, it performs the following operations in order which are a more specific, typical example.

### <Position Corresponding to 10 Seconds Before the End of Autonomous-Drive Possible Interval>

A character message “Ten seconds to the end of the autonomous drive” is displayed. The displayed number indicating the time to the end of the autonomous drive counts down every second as time elapses.

At the same time, an icon urging the driver to grip the steering wheel is displayed in yellow and an attention-arousing sound “boing” is emitted. And a simulated voice “Start driving yourself” is emitted.

### <Position Corresponding to 3 Seconds Before the End of Autonomous-Drive Possible Interval>

Character messages “Start driving yourself quickly” and “Three seconds to the end of the autonomous drive” are displayed. At the same time, the color of the icon that urges the driver to grip the steering wheel is changed to red.

### <Operations Performed Upon Gripping of Steering Wheel by Driver>

A character message “Switching to a manual drive has been made” is displayed. At the same time, the color of the icon that urges the driver to grip the steering wheel is changed to white and a simulated voice “Switching to a manual drive has been made. Please drive safely” is emitted.

<Operations Performed Upon Termination of Autonomous-Drive Possible Interval (after the End of Interval)>

A character message “The autonomous drive has finished and the vehicle will stop. Please drive safely paying attention to the surrounding traffic situation.” And warning sounds are emitted intermittently and the vehicle is stopped.

### <Timing of Information Presentation by Vehicular Information Presenting Device 100>

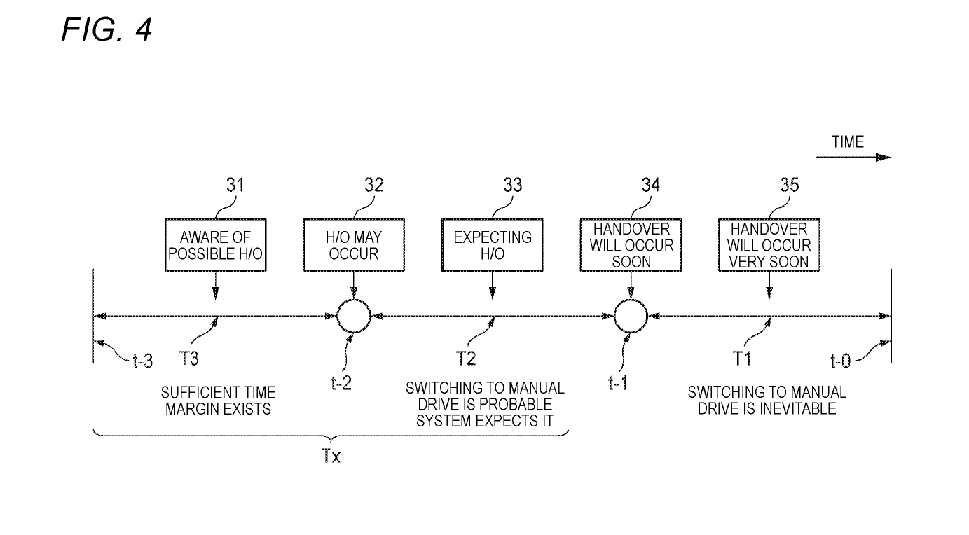

FIG. 4 shows a relationship between respective situations for individual intervals to an event-occurring position and target recognition levels of the driver. More specifically, FIG. 4 shows, in a situation that a handover (H/O) may occur at time t-0 in connection with a certain event, an example relationship between time points t-1, t-2, and t-3 before time t-0, intervals T1, T2, and T3, and target recognition levels 31-35 of the driver. An information presentation target interval Tx shown in FIG. 4 corresponds to timing for the vehicular information presenting device 100 to present information at step S18 shown in FIG. 2.

Time t-1 shown in FIG. 4 corresponds to timing to cause the driver to recognize that “the system will issue, soon, a handover request in connection with the event of the time t-0.” That is, the target recognition level 34 of the driver at time t-1 is “a handover will occur soon.” Time t-2 corresponds to timing to cause the driver to recognize that “the system may issue a handover request in connection with the event of the time t-0.” That is, the target recognition level 32 of the driver at time t-2 is “a handover may occur.” Time t-3 corresponds to timing that there exists a sufficient time margin with respect to time t-0.

Interval T1 from time t-1 to time t-0 is an interval in which the system recognizes that a handover will necessarily occur at time t-0. Interval T2 from time t-2 to time t-1 is an interval in which the system recognizes that a handover at time t-0 is probable and expects it to some extent. Interval T3 from time t-3 to time t-2 is an interval in which the system recognizes that there exists a sufficient time margin with respect to time t-0 when a handover may occur.

Thus, it suffices the target recognition level 31 of the driver in interval T3 be “aware of a possible handover.” The target recognition level 33 of the driver in interval T2 is “expecting a handover.” The target recognition level 35 of the driver in interval T1 is “a handover will occur very soon.”

In the information presentation target interval Tx corresponding to timing for the vehicular information presenting device 100 to present information at step S18 shown in FIG. 2, if there exists a proper time margin, it is important not to convey information to the driver too clearly so as not to impair the comfortability of the autonomous drive.

It is therefore preferable to present information to the driver at a lowest notification level as in the example shown in FIG. 3A. That is, by presenting information with relatively low intensity as in the example shown in FIG. 3A, it is possible to have the driver realize that a certain event will happen without impairing the comfortability of the autonomous drive. Where the probability of an encounter, the degree of emergency, or the degree of importance is high, by presenting information in an explicit manner with relatively high intensity as in the example shown in FIG. 3B, it is possible to convey a scheduled handover to the driver clearly and thereby enable a smooth handover.

Features of the above-described method for conveying information during an autonomous drive and vehicular information presenting device according to the embodiment of the invention will be summarized below concisely in the form of items [1] to [9]:

[1] A method for conveying information during an autonomous drive which presents information to a driver in a vehicle having, as running states, two or more states that are different from each other in the degree of involvement of the driver in drive control, wherein:

the running states include a first state in which the drive control is performed automatically and a second state that is higher in the degree of involvement of the driver than the first state; and

if an encounter with an event that may cause switching from the first state to the second state is predicted (S12), information relating to the event is conveyed to the driver using an output device in an output form that corresponds to a warning level relating to the predicted event (S18).

[2] The method for conveying information during an autonomous drive according to item [1], wherein:

the first state is a state in which the running speed and direction of the vehicle are controlled automatically and no assistance of the driver to the drive control is necessary; and

the second state is a state in which the running speed and direction of the vehicle are controlled automatically but assistance of the driver to the drive control is required.

[3] The method for conveying information during an autonomous drive according to item [1], wherein:

the first state is a state in which the running speed and direction of the vehicle are controlled automatically; and

the second state is a state in which at least one of the running speed and the running direction of the vehicle is controlled by the driver.

[4] The method for conveying information during an autonomous drive according to item [1], wherein:

the warning level relates to at least one of the probability of an encounter that is a probability of encountering the predicted event, the degree of emergency that indicates a time margin, and the degree of importance that indicates the seriousness of damage to be incurred by a resulting traffic accident; and

the output device is controlled so as to make a stimulus to be imparted to the driver weaker when the warning level is low than when the warning level is high (S17, S18).

[5] A vehicular information presenting device (100) for presenting information to a driver in a vehicle having, as running states, two or more states that are different from each other in the degree of involvement of the driver in drive control, wherein:

the running states include a first state in which the drive control is performed automatically and a second state that is higher in the degree of involvement of the driver in drive control than the first state; and

the vehicular information presenting device comprises:
an event prediction unit (autonomous drive control unit 10, S12) which predicts an encounter with an event that may cause switching from the first state to the second state; and
an information output control unit (20) which conveys information relating to the event to the driver using an output device (display devices 21, illumination devices 22, sound/voice output devices 23, vibration device 24, scent output device 25) in an output form that corresponds to a warning level relating to the predicted event if the event prediction unit predicts an encounter with the event.

[6] The vehicular information presenting device according to item [5], wherein:

the first state is a state in which the running speed and direction of the vehicle are controlled automatically and no assistance of the driver to the drive control is necessary; and

the second state is a state in which the running speed and direction of the vehicle are controlled automatically but assistance of the driver to the drive control is required.

[7] The vehicular information presenting device according to item [5], wherein:

the first state is a state in which the running speed and direction of the vehicle are controlled automatically; and

the second state is a state in which at least one of the running speed and the running direction of the vehicle is controlled by the driver.

[8] The vehicular information presenting device according to item [5], wherein the event prediction unit has a function of acquiring at least one of weather information and traffic information at places ahead of the vehicle on a scheduled drive route (S11) and predicts an encounter with the event using prescribed road map information, the weather information, and the traffic information (S12).

[9] The vehicular information presenting device according to item [5], wherein the information output control unit causes the output device to output a stimulus with such strength that it is noticed by the driver if the warning level is relatively low, and to output an explicit message if the warning level is relatively high (see FIGS. 3A and 3B).

What is claimed is:

1. A method for conveying information during an autonomous drive which presents information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state; and
if an encounter with an event that may cause switching from the first state to the second state is predicted, information relating to the event is conveyed to the driver using an output device in an output form that corresponds to a warning level relating to the predicted event.

2. The method for conveying information during an autonomous drive according to claim 1, wherein:
the first state is a state in which the running speed and direction of the vehicle are controlled automatically and no assistance of the driver to the drive control is necessary; and
the second state is a state in which the running speed and direction of the vehicle are controlled automatically but assistance of the driver to the drive control is required.

3. The method for conveying information during an autonomous drive according to claim 1, wherein:
the first state is a state in which the running speed and direction of the vehicle are controlled automatically; and
the second state is a state in which at least one of the running speed and the running direction of the vehicle is controlled by the driver.

4. The method for conveying information during an autonomous drive according to claim 1, wherein:
the warning level relates to at least one of the probability of an encounter that is a probability of encountering the predicted event, the degree of emergency that indicates a time margin, and the degree of importance that indicates the seriousness of damage to be incurred by a resulting traffic accident; and
the output device is controlled so as to make a stimulus to be imparted to the driver weaker when the warning level is low than when the warning level is high.

5. A vehicular information presenting device for presenting information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state; and
the vehicular information presenting device comprises:
an event prediction unit which predicts an encounter with an event that may cause switching from the first state to the second state; and
an information output control unit which conveys information relating to the event to the driver using an output device in an output form that corresponds to a warning level relating to the predicted event if the event prediction unit predicts an encounter with the event.

6. The vehicular information presenting device according to claim 5, wherein:
the first state is a state in which the running speed and direction of the vehicle are controlled automatically and no assistance of the driver to the drive control is necessary; and
the second state is a state in which the running speed and direction of the vehicle are controlled automatically but assistance of the driver to the drive control is required.

7. The vehicular information presenting device according to claim 5, wherein:
the first state is a state in which the running speed and direction of the vehicle are controlled automatically; and
the second state is a state in which at least one of the running speed and the running direction of the vehicle is controlled by the driver.

8. The vehicular information presenting device according to claim 5, wherein the event prediction unit has a function of acquiring at least one of weather information and traffic information at places ahead of the vehicle on a scheduled drive route and predicts an encounter with the event using prescribed road map information, the weather information, and the traffic information.

9. The vehicular information presenting device according to claim 5, wherein the information output control unit causes the output device to output a stimulus with such strength that it is noticed by the driver if the warning level is relatively low, and to output an explicit message if the warning level is relatively high.
